(19) United States
(12) Patent Application Publication
(10) Pub. No.: US 2025/0385879 A1
(43) Pub. Date: Dec. 18, 2025

(54) SYSTEMS AND METHODS FOR AN AI-BASED CONVERSATIONAL WEB APPLICATION

(71) Applicant: YAHOO ASSETS LLC, New York, NY (US)

(72) Inventors: Eric BAX, Sierra Madre, CA (US); Arundhyoti SARKAR, Woodinville, WA (US); Ruchita GARDE, Milpitas, CA (US); Will WAGNER, Costa Mesa, CA (US); Melissa GERBER, Rancho Mission Viejo, CA (US); Nikki THOMPSON, Bloomfield, NJ (US)

(21) Appl. No.: 18/743,614

(22) Filed: Jun. 14, 2024

(51) Int. Cl. H04L 51/02

(52) U.S. Cl. CPC H04L 51/02

(57) ABSTRACT

Disclosed are systems and methods that provide a decision-intelligence (DI)-based, computerized framework that provides advancements in how users interact with chatbots, as well as how they can engage with content and services over a computer network. The disclosed framework provides a conversational web experience whereby a user can engage with a chatbot or chatbots simultaneously and/or sequentially via a series of handoffs that are correlated to the context of the user's engagement. Thus, the types and/or interactive content the user is engaging with on the Internet can drive the types, quantities and/or timing of how chatbots are presented to the user for purposes of facilitating the engagement of the user with network hosted content.

### FIELD OF THE DISCLOSURE

The present disclosure is related to artificial intelligence (AI)-based conversational web experience, and more particularly, to a decision intelligence (DI)-based computerized framework for engaging one or multiple chatbots to enable directed interactions by and/or between a user and/or specific portals on the Internet.

### SUMMARY OF THE DISCLOSURE

By way of background, there are many instances for which a user browsing the Internet using a screen and responding by hand are impossible or inconvenient. For example, such instances can include when using small devices (e.g., watch, ring, necklace and the like), when using devices that operate via conversation by design and may not have a screen, while using hands and eyes for other tasks, and/or for users who do not have use of hands and/or eyes due to a disability, and the like. For such instances, and by preference for some users, there is the possibility of doing something like browsing the internet conversationally, either partially or wholly hands-free.

One way to do this is to have a chatbot or chatbots represent each organization or set of data and functions that operates as the basis for a website. In such implementations, each chatbot can draw its data from a website and/or directly from a database, with the presentation layer involving the conversion of such information to a conversational format rather than producing an HTML page on a browser. In such systems, users may converse with one or more chatbots in the course of a session, moving from one chatbot to another to learn about different topics or to complete different tasks. Moreover, similar to links on websites, a chatbot may recommend that a user speak to a different chatbot. Similarly, the user may converse with multiple chatbots at once, even encouraging them to converse with each other so that the user may listen and learn or so that they can work out details of a user's transaction.

Accordingly, as disclosed herein, the disclosed systems and methods provide a novel computerized framework that enables such conversational web experience. In some embodiments, such experience can be tied to different forms of access, which can be associated with, but not limited to, subscriptions, fees, sales of items, read/write access, and the like. Thus, in some embodiments, there may be incentives for chatbots to avail themselves to such users to increase their performance metrics, while proportionally increasing the experience for the user.

As discussed herein, a chatbot is a software application designed to simulate human conversation through text or voice interactions, leveraging artificial intelligence (AI) technologies, particularly natural language processing (NLP) and machine learning (ML). Such technologies enable chatbots to respond to user inputs in a manner that mimics human communication. Typically integrated into websites, messaging apps, mobile apps, and other digital platforms, chatbots provide automated assistance, support, and engagement.

The core components of a chatbot can include the user interface (UI), NLP, dialogue management, backend integration, AI/ML models and business logic, inter alia. Accordingly, the UI is the medium through which users interact with the chatbot, such as a chat window or a voice interface. Natural Language Processing (NLP) allows the chatbot to interpret human language, involving both language understanding and language generation. Dialogue management manages the flow of the conversation, maintaining context and determining appropriate responses based on user inputs and conversation history. Backend integration connects the chatbot to databases, application program interfaces (APIs), and other backend systems, enabling it to retrieve or update information as needed. AI/ML models enable the chatbot to improve over time by learning from interactions, enhancing its ability to understand user intents and refine responses. Business logic provides a set of rules and algorithms that guide the chatbot's behavior in various scenarios, ensuring it aligns with the specific goals and requirements of the entity, resource and/or organization using it.

Accordingly, chatbots can be AI-powered chatbots that use advanced AI and ML techniques to handle more complex interactions, learning from data and improving their performance over time. For example, in addition to the conversational mechanisms discussed herein, chatbots can be utilized in various applications, such as customer service, virtual assistants, information retrieval, and booking systems, providing users with instant and efficient assistance, and the like.

As discussed herein, implementation of an LLM (and/or any other form of AI/machine learning (ML) model) can form the technical basis for the conversations via a chatbot(s). Some LLMs have, among other features and capabilities, theory of mind, abilities to reason, abilities to make a list of tasks, abilities to plan and react to changes (via reviewing their own previous decisions), abilities to compute based on multiple data sources (and types of data-multimodal), abilities to have conversations with humans in natural language, abilities to adjust, abilities to interact with and/or control application program interfaces (APIs), abilities to remember information long term, abilities to use tools (e.g., read multiple schedules/calendars, command other systems, search for data, and the like), abilities to use other LLM and other types of AI/ML (e.g., neural networks to look for patterns, recognize humans, pets, and the like, for example), abilities to improve itself, abilities to correct mistakes and learn using reflection, and the like.

Thus, as provided herein, the disclosed integration of such LLM technology, as well as known or to be known AI/ML models, to execute the disclosed conversational web, chatbot-based mechanisms discussed herein provide an improved system that can improve how users are capable of interacting with network-hosted content, inter alia.

According to some embodiments, a method is disclosed for a DI-based computerized framework for conversational web experience. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a conversational web experience.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

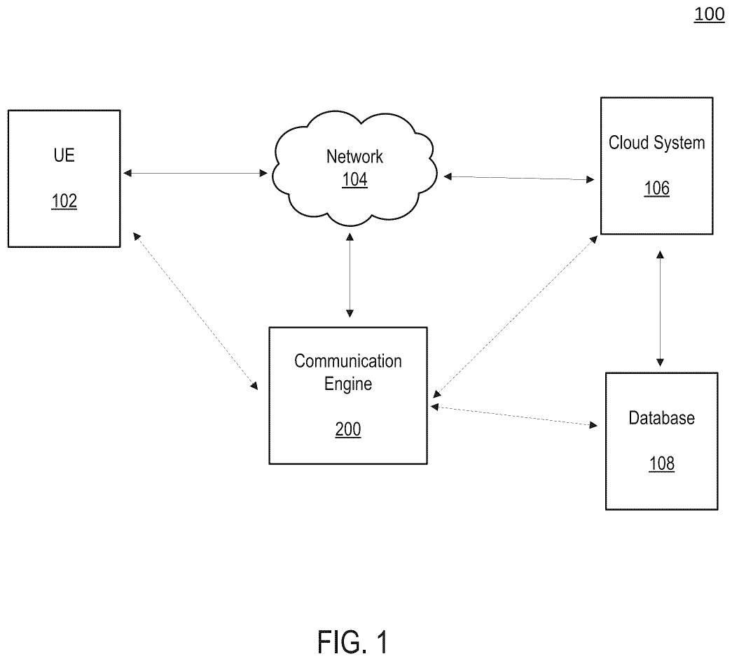

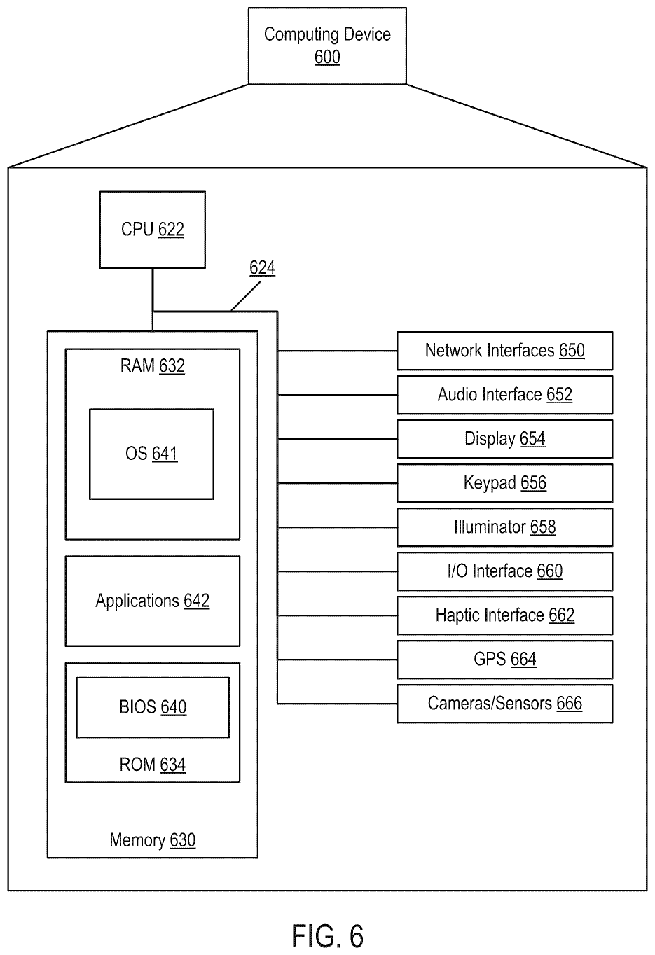

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and communication engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Yahoo!®), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or communication engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

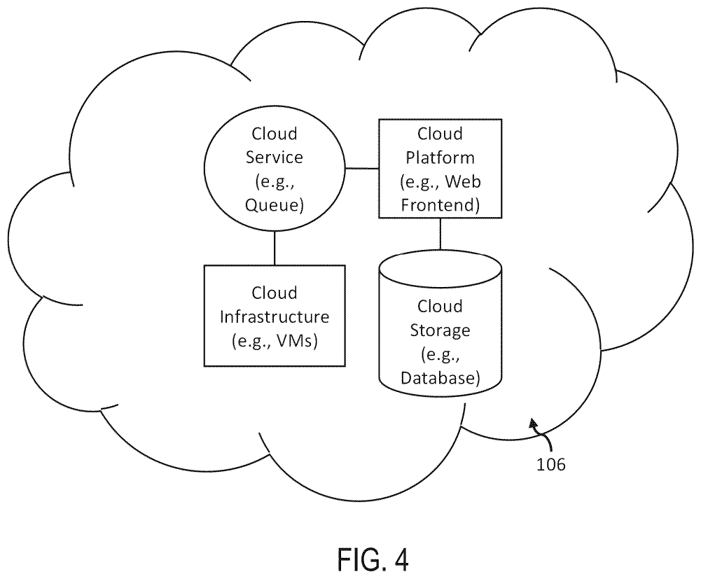

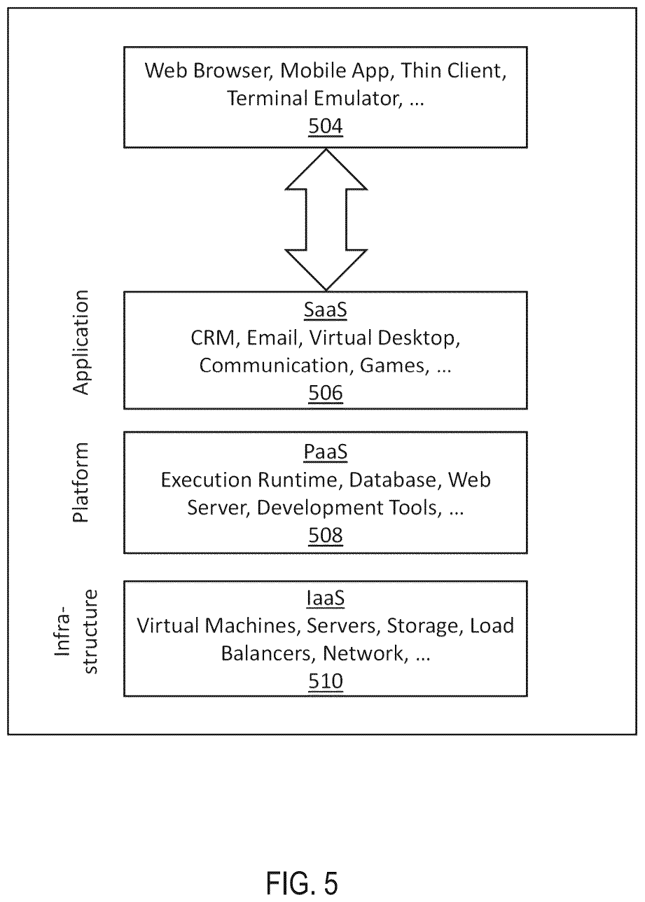

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Communication engine 200, as discussed above and further below in more detail, can include components for the disclosed functionality. According to some embodiments, communication engine 200 may be a special purpose machine or processor, and can be hosted by a device on network 104, within cloud system 106, and/or on UE 102. In some embodiments, engine 200 may be hosted by a server and/or set of servers associated with cloud system 106.

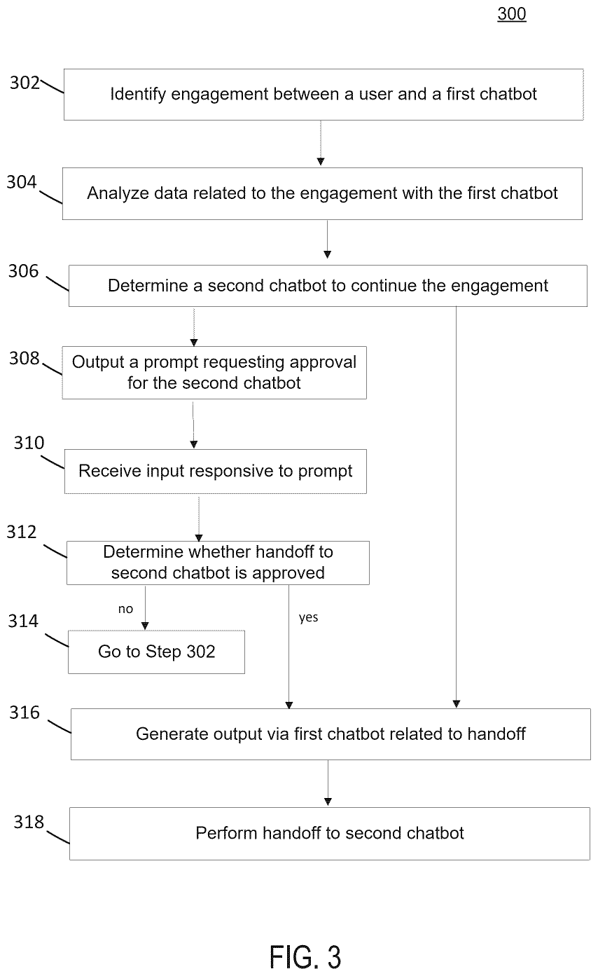

According to some embodiments, as discussed in more detail below, communication engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, communication engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

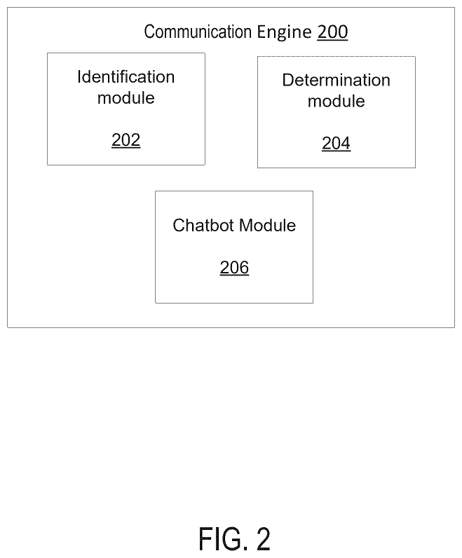

As illustrated in FIG. 2, according to some embodiments, communication engine 200 includes identification module 202, determination module 204 and chatbot module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed conversational web functionality. As provided below, the disclosed framework's configuration and implementation can provide a computerized suite of tools for providing advancements in how users interact with LLMs, as well as providing mechanisms for how such users can engage with content and services over a computer network.

According to some embodiments, Steps 302 and 314 of Process 300 can be performed by identification module 202 of communication engine 200; Steps 304, 306 and 312 can be performed by determination module 204; and Steps 308, 310, 316 and 318 can be performed by chatbot module 206.

According to some embodiments, Process 300 begins with Step 302 where engine 200 can identify an engagement by a user, via their device (e.g., UE 102, discussed supra), with a first chatbot. For example, Step 302 can involve a user request access to a first network (or electronic) resource (e.g., a first website), whereby the request, for example, can involve a voice command “Please open in xyz.com in the Safari browser.” In some embodiments, as discussed above, such engagement can involve the user providing input, and the chatbot responding to the input and providing an output, which can further trigger and/or cause further input from the user, and so on.

In some embodiments, Step 302 can further involve identifying an indication that the engagement is requested to be continued via another chatbot(s), which can be based on, but not limited to, a request from the user (e.g., input from the user, such as, “can we ask ‘abc’ resource?”, instructions generated from the first chatbot, and/or via engine 200 determining that another resource is better suited for handling the user's current context of engagement, which can be performed via the analysis and determinations from Steps 304 and 306, discussed infra).

In Step 304, engine 200 can analyze the data related to the engagement with the first chatbot. Such analysis can involve analyzing information related to, but not limited to, the user inputs, first chatbot outputs, user information (e.g., user identifier (ID), user profile/account information, user location, IP address of the user's device, device capabilities of the user's device, a time, date, and the like), first chatbot information (e.g., type of chatbot, and the like), first electronic resource information (e.g., resource ID (e.g., website address, domain, and the like), content/context of the resource, and the like), and the like.

In some embodiments, such data can be collected from Step 302, then analyzed in Step 304. In some embodiments, upon collection of such data, engine 200 can cause such data to be stored in database 108 (e.g., in association with an account of the user, first chatbot, first electronic resource, and/or some combination thereof).

According to some embodiments, analysis of the engagement data can involve engine 200 performing a computational analysis that involves execution of an AI/ML model and/or LLM.

According to some embodiments, the AI models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of a AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 306, engine 200 can determine a second chatbot to continue the engagement. While the discussion herein will involve only mention of a single second chatbot, it should not be construed as limiting, as it should be understood that multiple chatbots can be pinged, queried and/or initiated to continue the engagement in a similar manner as discussed herein. For example, a set of second chatbots can be engaged, which can occur sequentially and/or in a substantially simultaneous manner (e.g., talk to two chatbot at the same time related to the same topic).

In some embodiments, Step 306's determination can involve engine 200 determining that the conversation with the first chatbot has transitioned from a first topic to a second topic, for which another chatbot may be more suited than the first chatbot.

By way of example, the user is interacting with a first chatbot related to mobile phones (e.g., a chatbot for a phone carrier resource); however, when the conversation turns to tablets (e.g., iPad®, for example), such context (as determined via Step 304's analysis) indicates that another resource and another chatbot are needed to provide the proper response. Therefore, as in Step 306, engine 200 can identify an electronics provider and its corresponding chatbot.

According to some embodiments, selection/identification of the second chatbot can be determined by an auction, where the auction operation executed by engine 200 can involve and/or be based on the AI/ML and/or LLM analysis (in Step 304), discussed supra. In some embodiments, such auction can include handoff criteria, which can include, but not be limited to, a user remaining in the conversation for a specified amount of time after the handoff, a sale to the user during the conversation, a sale after the conversation, or the user choosing to converse again, later, after the handoff, and the like. In some embodiments the handoff criteria can further involve, but not be limited to, an amount of money paid for the handoff (e.g., cryptocurrency and/or FIAT), whether the handoff resulted in a conversion, and the like. In some embodiments the handoff criteria can further involve, but not be limited to, how long the first chatbot remains engaged (e.g., an overlap of chatbot experiences, as discussed below related to Steps 316 and 318), how long the second chatbot remains active, whether there is an overlap of information between the first and second chatbots, and the like.

In some embodiments, the handoff criteria can be based on, but not limited to, the data (from Steps 302-204), user information (from a user profile, which can include, but is not limited to, account information, behavior information (e.g., purchase history, for example), demographic information, geographic information, and the like), information related to the first network resource, first chatbot, second network resource, second chatbot, and the like, a context of the engagement (from Step 302—for example, information about the user, conversation, time, place, and the like), and the like, or some combination thereof.

Accordingly, in some embodiments, Step 306's determination can involve inputting the handoff criteria into a prediction model (e.g., AI/ML model, as discussed above), and determine a type and/or ID of the second chatbot (e.g., or a set of chatbots, for which the top ranked chatbot is identified). In some embodiments, such identification can involve the second network resource (or a controlling entity or engine related thereto) providing a bid for the selection and implementation into Process 300, as discussed herein.

In some embodiments, a set of second chatbots can be identified, whereby bids can be received from multiple entities/engines. In some embodiments, engine 200 can implement a Vickrey-Clarke-Groves (VCG) auction, a first-price auction, and/or a second-price auction. In some embodiments, bids can be contingent on one or more actions (e.g. $0.01 for a handoff plus $1.00 if the handoff results in a sale). In some embodiments, allocations may be winner-take-all, proportional, or quasi-proportional. In some embodiments, there can be multiple winners per auction, resulting in the UI presenting multiple candidate chatbots and having the user select among them.

Turning back to Process 300, in some embodiments, processing can continue from Step 306 to Step 308 or to Step 316. According to some embodiments, when proceeding to Step 308, engine 200 enables an interaction with the user that provides the user the ability to accept, reject and/or modify the second chatbot. According to some embodiments, processing directly to Step 316 involves engine 200 automatically triggering the handoff procedures from the first chatbot to the second chatbot, as discussed in more detail below.

Thus, according to some embodiments, in Step 308, engine 200 can output a prompt that requests approval of the second chatbot. In some embodiments, as discussed above, the prompt can be generated by engine 200 leveraging an LLM (e.g., executing an LLM and/or communicating a request to an LLM), where the LLM analyzes the data (from Steps 302-304) and/or information related to the identified second chatbot, and generates a prompt for the user. For example, the prompt can state “Do you want to switch to a chatbot that can provide you information about tablet computers?”

In Step 310, in response to the prompt in Step 308, engine 200 can receive a response. For example, the prompt in Step 308 can be output (e.g., audibly communicated via the user's device), for which an audible response is received. For example, the response can include any type of response, such as, but not limited to, as non-limiting examples: “Yes”, “No”, “Are there other options”, “Is there another provider”, “What kind of deals”, and the like.

In Step 312, engine 200 can again leverage the LLM to analyze the response (from Step 310) and determine whether a handoff to the identified second chatbot is approved. In some embodiments, when the response indicates that the second chatbot is not approved, processing can recursively proceed back to Step 302, where further analysis of the identification of another chatbot can proceed.

In some embodiments, when the identified second chatbot (from Step 306) is approved by the user, processing can proceed to Step 316.

In Step 316, which can be performed in response to Step 314 or Step 306, discussed supra and illustrated in FIG. 3, the first chatbot can generate an output that indicates a handoff to the second chatbot. For example, the first chatbot can output: “Please see the input dialog box for this other chatbot that can address your questions about tablet computers. Let me know if you have other questions.” As discussed above, such output via the LLM executed by engine 200 can be audibly provided and/or displayed as content on a screen (e.g., an image or video, for example).

And, in Step 318, engine 200 can execute a handoff from the first chatbot to the second chatbot. In some embodiments, such handoff can be performed via the handoff criteria, discussed above. According to some embodiments, as discussed herein, user interactions with a first chatbot can be seamlessly handed off to a second chatbot, or multiple chatbots. According to some embodiments, when handing off interactions between chatbots, engine 20 can implement a standardized handoff protocol, which can involve packaging relevant data into a structured format (e.g., JSON, for example) that includes, but is not limited to, the conversation history, user information, the reason for the handoff, and any other context that can help the receiving chatbot continue the conversation seamlessly. Such data packet can be transmitted via APIs or webhooks, which serve as the communication channels between the chatbots. In some embodiments, for example, RESTful APIs can be used for their stateless nature and broad compatibility, while webhooks allow for real-time, event-driven transfers.

According to some embodiments, to manage such handoffs effectively, a chatbot registry can be maintained. Such registry can be configured as a dynamic database that keeps track of all available chatbots, their current status (e.g., active, busy, offline), and their specialized capabilities. In some embodiments, when a handoff is needed, routing logic can be a factor, which can use decision trees or more ML algorithms that analyze the user's intent, the current chatbot's limitations, and the registry data to determine the most appropriate chatbot to handle the next part of the conversation.

According to some embodiments, security is paramount in these inter-bot communications. Token-based authentication, such as JWT (JSON Web Tokens) or OAuth, can be implemented to ensure that only authorized chatbots can access and modify user data. This protects user privacy and prevents malicious bots from interfering with conversations. Throughout this process, maintaining a seamless user experience can be critical, and the handoff should be seamless to the user, with clear, friendly messages explaining any noticeable transition.

Moreover, in some embodiments, engine 200 can execute operations to perform comprehensive logging and analytics. For example, every handoff, its reason, success rate and user feedback can be recorded (e.g., in database 108). In some embodiments, such data can be analyzed to identify bottlenecks, refine the routing logic, optimize chatbot specializations and ultimately enhance user satisfaction.

In some embodiments, upon engine 200 detects that that the handoff has failed (e.g., due to technical issues or unforeseen user queries), engine 200 can execute fallback mechanisms that route the conversation to a default chatbot with broad capabilities or, in some embodiments, back to the first chatbot.

Accordingly, upon performing the handoff, engine 200 can continue the processing of Process 300 by reverting back to Step 302, where the engagement by the user with the second chatbot can be identified and monitored. For example, via such analysis, the first chatbot can be reengaged and/or a third chatbot(s) can be engaged via such processing.

Therefore, according to some embodiments, the disclosed framework provides a conversational web experience whereby a user can engage with a chatbot or chatbots simultaneously and/or sequentially via a series of handoffs that are correlated to the context of the user's engagement. Thus, the types and/or interactive content the user is engaging with on the Internet can drive the types, quantities and/or timing of how chatbots are presented to the user for purposes of facilitating the engagement of the user with network hosted content.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising steps of:
identifying engagement between a user and a first chatbot, the first chatbot associated with a first electronic resource, the engagement corresponding to a first topic;
analyzing the engagement, and identifying a second chatbot, the second chatbot configured to provide engagement functionality with a second electronic resource related to a second topic; and
executing a handoff of the engagement from the first chatbot to the second chatbot, the handoff enabling the user to continue the engagement respective to the second topic with the second chatbot.

2. The method of claim 1, further comprising:
determining, based on the analysis of the engagement, that the engagement transitioned from the first topic to the second topic, wherein the handoff to the second chatbot is based on the transition determination.

3. The method of claim 1, further comprising the first chatbot and the second chatbot remaining available for interaction with the user during the handoff.

4. The method of claim 1, further comprising the first chatbot and the second chatbot remaining available for interaction with the user after the handoff.

5. The method of claim 1, further comprising:
outputting, via a large language model (LLM), a prompt requesting approval of the second chatbot;
receiving, in response to the prompt, feedback from the user;
analyzing, via the LLM, the feedback; and
performing the handoff to the second chatbot based on the LLM analysis of the feedback.

6. The method of claim 1, further comprising:
identifying a set of second chatbots, each of the second chatbot providing information related to the second topic;
executing auction operations with each of the set of second chatbots, the auction operations enabling each of the set of second chatbots to bid for a slot within a user interface (UI) on a device of the user; and
selecting the second chatbot based on the auction operations.

7. The method of claim 1, further comprising conversational engagement with the first chatbot comprising conversational interactions with the user and the first chatbot, wherein the conversational interactions comprise at least one of an audible output and displayed content on a device of the user.

8. The method of claim 1, further comprising identifying whether either the first electronic resource or the second electronic resource is a network resource.

9. A system comprising:
a processor configured to:
identify engagement between a user and a first chatbot, the first chatbot associated with a first electronic resource, the engagement corresponding to a first topic;
analyze the engagement, and identify a second chatbot, the second chatbot configured to provide engagement functionality with a second electronic resource related to a second topic; and
execute a handoff of the engagement from the first chatbot to the second chatbot, the handoff enabling the user to continue the engagement respective to the second topic with the second chatbot.

10. The system of claim 9, wherein the processor is further configured to:
determine, based on the analysis of the engagement, that the engagement transitioned from the first topic to the second topic, wherein the handoff to the second chatbot is based on the transition determination.

11. The system of claim 9, wherein the processor is further configured for the first chatbot and the second chatbot to remain available for interaction with the user during the handoff.

12. The system of claim 9, wherein the processor is further configured for the first chatbot and the second chatbot to remain available for interaction with the user after the handoff.

13. The system of claim 9, wherein the processor is further configured to:
output, via a large language model (LLM), a prompt requesting approval of the second chatbot;
receive, in response to the prompt, feedback from the user;
analyze, via the LLM, the feedback; and
perform the handoff to the second chatbot based on the LLM analysis of the feedback.

14. The system of claim 9, wherein the processor is further configured to:
identify a set of second chatbots, each of the second chatbot providing information related to the second topic;
execute auction operations with each of the set of second chatbots, the auction operations enabling each of the set of second chatbots to bid for a slot within a user interface (UI) on a device of the user; and
select the second chatbot based on the auction operations.

15. The system of claim 9, wherein the processor is further configured for the conversational engagement with the first chatbot comprising conversational interactions with the user and the first chatbot, wherein the conversational interactions comprise at least one of an audible output and displayed content on a device of the user.

16. The system of claim 9, wherein the processor is further configured to:
identify whether either the first electronic resource or the second electronic resource is a network resource.

17. A non-transitory computer-readable storage medium tangibly encoded with computer-executable instructions that when executed by a device, perform a method comprising:
identifying engagement between a user and a first chatbot, the first chatbot associated with a first electronic resource, the engagement corresponding to a first topic;
analyzing the engagement, and identifying a second chatbot, the second chatbot configured to provide engagement functionality with a second electronic resource related to a second topic; and
executing a handoff of the engagement from the first chatbot to the second chatbot, the handoff enabling the user to continue the engagement respective to the second topic with the second chatbot.

18. The non-transitory computer-readable storage medium of claim 17, further comprising:
determining, based on the analysis of the engagement, that the engagement transitioned from the first topic to the second topic, wherein the handoff to the second chatbot is based on the transition determination.

19. The non-transitory computer-readable storage medium of claim 17, further comprising:
outputting, via a large language model (LLM), a prompt requesting approval of the second chatbot;
receiving, in response to the prompt, feedback from the user;
analyzing, via the LLM, the feedback; and
performing the handoff to the second chatbot based on the LLM analysis of the feedback.

20. The non-transitory computer-readable storage medium of claim 17, further comprising:
identifying a set of second chatbots, each of the second chatbot providing information related to the second topic;
executing auction operations with each of the set of second chatbots, the auction operations enabling each of the set of second chatbots to bid for a slot within a user interface (UI) on a device of the user; and
selecting the second chatbot based on the auction operations.
